(19) United States
(12) Patent Application Publication
(10) Pub. No.: US 2025/0039317 A1
(43) Pub. Date: Jan. 30, 2025

(54) IMAGE PROCESSING APPARATUS AND CONTROL METHOD THEREFOR

(71) Applicant: CANON KABUSHIKI KAISHA, Tokyo (JP)

(72) Inventor: ARAN KUNIMATSU, Kanagawa (JP)

(21) Appl. No.: 18/781,638

(22) Filed: Jul. 23, 2024

(30) Foreign Application Priority Data
Jul. 27, 2023 (JP) 2023-122199

(51) Int. Cl. H04N 1/00; H04N 1/44

(52) U.S. Cl. CPC H04N 1/00962; H04N 1/4413; H04N 1/00464; H04N 2201/0094

(57) ABSTRACT

An image processing apparatus includes one or more memories storing instructions, and one or more processors capable of executing the instructions causing the image processing apparatus to execute initialization processing for collectively initializing a plurality of settings on the image processing apparatus, wherein, as the initialization processing based on selection of initialization of a network setting, the network setting is initialized, and on a setting on which a setting value limitation is imposed by a security policy, setting processing is executed in compliance with the limitation.

### BACKGROUND OF THE DISCLOSURE

### Field of the Disclosure

The present disclosure relates to an image processing apparatus and a control method therefor.

### Description of the Related Art

It may be desirable that personal computers (PCs) and server apparatuses (e.g., a file server, an authentication server, etc.) that are connected to a network in an office or the like operate in compliance with a security policy determined for each office. The security policy is the basic policy relating to information security of an entire company, which collectively stipulates policies on how to use information, how to prevent unauthorized entries from the outside, and how to prevent leak of information.

Examples of devices connected to an office network include not only PCs and server apparatuses, but also image processing apparatuses, such as a multifunction peripheral (MFP) and a printer. Recent image processing apparatuses are configured not only to simply print images and transmit printed images, but also to provide a user with a web user interface (UI) for operating an image processing apparatus from a web browser on a PC and provide the user with various cloud services in collaboration with a cloud server. In other words, the recent image processing apparatuses have the same role as other PCs or server apparatuses that are present on the network. Accordingly, to maintain safe and secure office environments, it may be desirable that not only PCs and server devices, but also image processing apparatuses comply with a security policy.

Complying with a security policy means imposing a limitation on an operation of an image processing apparatus from a security perspective in order to prevent unauthorized use or information leakage, for example, by making a user authentication necessary when the image processing apparatus is operated, or by making encryption of a communication path necessary.

Such an image processing apparatus performs control processing to maintain the state in which the image processing apparatus complies with a security policy. Japanese Patent Application Laid-Open No. 2017-163557 discusses a technique in which, if a certain security policy is set, values in specific setting items related to the security policy are set as fixed values, and the set values cannot be changed by a user other than a security administrator.

The recent image processing apparatuses have various functions and have a large number of setting items for allowing the various functions to appropriately operate. Some apparatuses also have a function for collectively resetting the set values of the setting items to initial values (factory default values) (this function is referred to as a “setting value initialization function” or “setting reset function”). In this case, it may be desirable to execute the setting value initialization function so that specific setting values on which a limitation is imposed by a security policy can comply with the security policy in order to maintain the state in which the setting values comply with the security policy.

Japanese Patent Application Laid-Open No. 2022-134175 discusses a technique for checking whether a limitation is imposed on each setting item of an image processing apparatus by a security policy, and for resetting only setting items on which no limitation is imposed by the security policy to initial values.

However, in the method of related art in which whether to initialize setting items is switched based on a result of checking whether a limitation is imposed on each setting item by a security policy, a processing load for checking increases in proportion to an increase in the number of setting items.

### SUMMARY OF THE DISCLOSURE

According to an aspect of the present disclosure, an image processing apparatus includes one or more memories storing instructions, and one or more processors capable of executing the instructions causing the image processing apparatus to execute initialization processing for collectively initializing a plurality of settings on the image processing apparatus, wherein, as the initialization processing based on selection of initialization of a network setting, the network setting is initialized, and on a setting on which a setting value limitation is imposed by a security policy, setting processing is executed in compliance with the limitation.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a system including an image processing apparatus according to a first exemplary embodiment of the present disclosure.

FIG. 2 is an external view of the image processing apparatus according to the first exemplary embodiment.

FIG. 3 is a block diagram illustrating a configuration of the image processing apparatus according to the first exemplary embodiment.

FIG. 4 is a diagram schematically illustrating a configuration of an operation display unit of the image processing apparatus according to the first exemplary embodiment.

FIG. 5 is a block diagram conceptually illustrating a software configuration of the image processing apparatus according to the first exemplary embodiment.

FIGS. 6A and 6B are diagrams schematically illustrating setting item management information of the image processing apparatus according to the first exemplary embodiment.

FIG. 7 is a diagram schematically illustrating a dependency relationship between a security policy setting and other settings on the image processing apparatus according to the first exemplary embodiment.

FIG. 8A is a diagram illustrating a screen to be displayed by a web browser of a terminal apparatus during the security policy setting on the image processing apparatus according to the first exemplary embodiment.

FIG. 8B is a diagram illustrating a screen to be displayed by the web browser of the terminal apparatus during the security policy setting on the image processing apparatus according to the first exemplary embodiment.

FIG. 8C is a diagram illustrating a screen to be displayed by the web browser of the terminal apparatus during the security policy setting on the image processing apparatus according to the first exemplary embodiment.

FIG. 8D is a diagram illustrating a screen to be displayed by the web browser of the terminal apparatus during the security policy setting on the image processing apparatus according to the first exemplary embodiment.

FIG. 9 is a flowchart illustrating security policy setting processing to be performed by the image processing apparatus according to the first exemplary embodiment.

FIG. 10 is a screen flow diagram illustrating a setting screen for setting items on which a setting change limitation is imposed by a security policy on the image processing apparatus according to the first exemplary embodiment.

FIG. 11 is a screen flow diagram illustrating a setting screen to be displayed when a setting reset function of the image processing apparatus according to the first exemplary embodiment is executed.

FIG. 12 is a flowchart illustrating network setting reset processing to be performed by the image processing apparatus according to the first exemplary embodiment.

FIG. 13 is a flowchart illustrating all settings reset processing to be performed by the image processing apparatus according to the first exemplary embodiment.

FIG. 14 is a screen flow diagram illustrating a setting screen to be displayed when a setting reset function of an image processing apparatus according to a second exemplary embodiment is executed.

FIG. 15 is a flowchart illustrating setting reset processing to be performed by the image processing apparatus according to the second exemplary embodiment.

### DESCRIPTION OF THE EMBODIMENTS

Exemplary embodiments of the present disclosure will be described below with reference to the drawings. It should be understood that the following exemplary embodiments may be changed or modified as appropriate on the basis of the ordinary knowledge of those skilled in the art without departing from the scope of the present disclosure, and such changes or modifications are also included within the scope of the present disclosure.

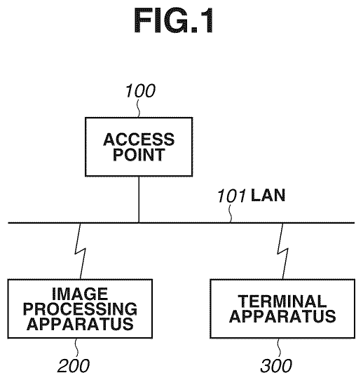

First, a network configuration according to a first exemplary embodiment will be described with reference to FIG. 1. The network configuration to be described below is merely an example of embodiments and can be applied to various configurations in which an image processing apparatus and a terminal apparatus can communicate with each other via a wired or wireless communication. It is not intended to limit the network configuration to the configuration example illustrated in FIG. 1. In the following description and the drawings, a network may be abbreviated as “NW”.

FIG. 1 is a block diagram illustrating a configuration example of a system including an image processing apparatus according to the first exemplary embodiment of the present disclosure. The system according to the first exemplary embodiment includes a local area network (LAN) 101, which is constructed by an access point 100, and an image processing apparatus 200 and a terminal apparatus 300, which are each connected to the LAN 101. In this case, the connection configuration of the LAN 101 may be wired communication or wireless communication. For example, the LAN 101 is connected via Wireless Fidelity (Wi-Fi®) that is a communication standard compliant with Institute of Electrical and Electronics Engineers (IEEE) 802.11 series. In the LAN 101, different internet protocol (IP) addresses are allocated to the image processing apparatus 200 and the terminal apparatus 300 by the access point 100. This makes it possible for apparatuses within the LAN 101 to communicate with each other by designating each other's IP address as a destination address.

The image processing apparatus 200 is, for example, an inkjet printer, and provides a user with functions such as a printing function, a scanning function, and a facsimile (FAX) function. The image processing apparatus 200 further has a web server function, which makes it possible to receive a request and transmit a response using Hypertext Transfer Protocol (HTTP) communication. The functions incorporated in the image processing apparatus 200 are not limited to these functions. Some of the foregoing functions may be omitted and functions other than the foregoing functions may be incorporated in the image processing apparatus 200. The image processing apparatus 200 is not limited to an inkjet printer, but instead may be any other apparatus, such as a laser beam printer or an office multifunction peripheral (MFP).

The terminal apparatus 300 is, for example, a smartphone, and provides the user with a web browser function within the terminal apparatus 300. In the web browser function, the terminal apparatus 300 transmits a request and receives a response using HTTP communication, and displays a screen in association with the communication. The functions incorporated in the terminal apparatus 300 are not limited to these functions, and any function other than the foregoing functions may be incorporated in the terminal apparatus 300.

The terminal apparatus 300 is not limited to a smartphone, but instead may be any other apparatus, such as a personal computer (PC) or a tablet terminal.

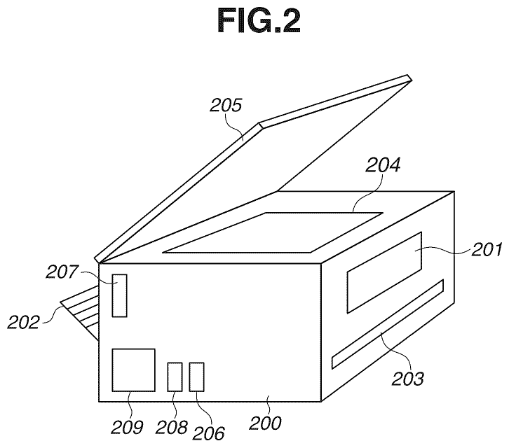

FIG. 2 is a diagram illustrating an example of an external view of the image processing apparatus 200. In the first exemplary embodiment, an inkjet printer (printing apparatus) is illustrated as an example of the image processing apparatus 200. This printer is an MFP printer including a printing function, a scanning function, a FAX function, and other functions.

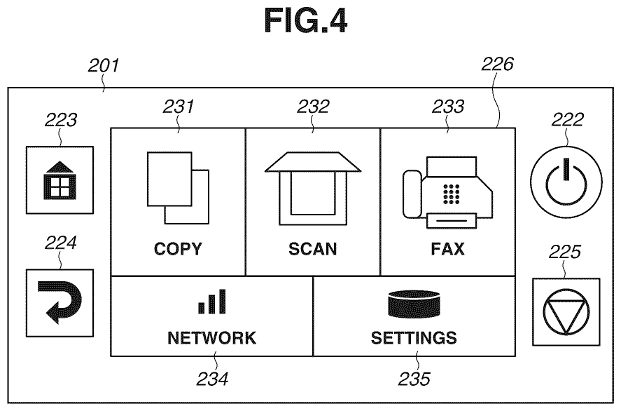

An operation display unit 201 includes a display and buttons used to operate the image processing apparatus 200. The operation display unit 201 will be described in detail below with reference to FIG. 4.

A print sheet insertion port 202 is an insertion port for setting various sizes of sheets. The sheets set on the print sheet insertion port 202 are conveyed one by one to a print unit, and desired printing is performed on the sheets. The sheets on which desired printing has been performed are discharged from a print sheet discharge port 203.

A platen glass 204 is a glass-like transparent table, on which a document is placed to read the document with a scanner. A platen glass pressing plate 205 is a cover for pressing a document onto the platen glass 204 so that the document does not move when the document is scanned by the scanner and external light does not enter a scan unit.

A universal serial bus (USB) communication unit 206 includes a circuit and a USB connector for the image processing apparatus 200 to communicate with the external terminal apparatus 300 and the like via a USB connection.

A wireless LAN communication unit 207 incorporates a circuit, such as an antenna, for establishing a wireless communication, such as the wireless connection described above or a direct connection where the image processing apparatus 200 itself functions as an access point to construct a wireless LAN.

A FAX communication unit 208 includes a circuit for FAX transmission and reception, and a connector for a telephone line.

A power supply unit 209 includes a power supply circuit and a power supply jack for supplying power to the image processing apparatus 200.

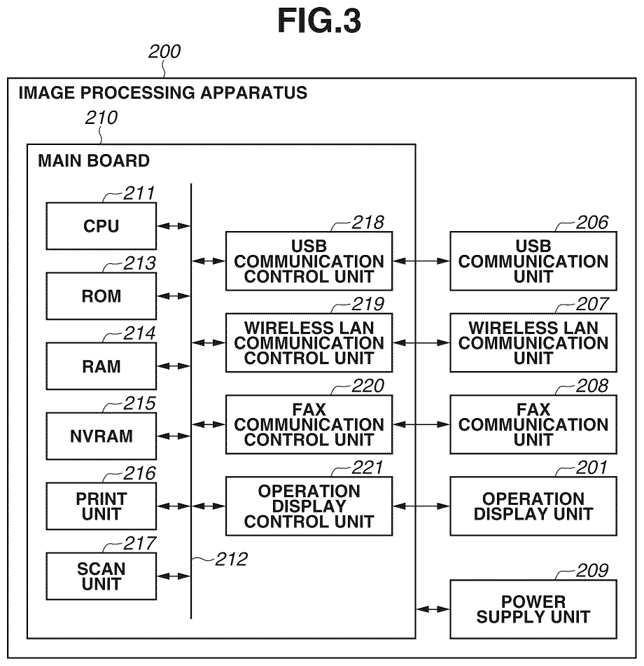

FIG. 3 is a block diagram illustrating an example of a configuration of the image processing apparatus 200.

The image processing apparatus 200 includes a main board 210 that controls the overall operation of the image processing apparatus 200, the operation display unit 201, the USB communication unit 206, the wireless LAN communication unit 207, the FAX communication unit 208, and the power supply unit 209.

A central processing unit (CPU) 211 configured as a microprocessor located on the main board 210 operates based on control programs stored in a read-only memory (ROM) 213 connected via an internal bus 212 and data stored in a random access memory (RAM) 214. Various settings on the image processing apparatus 200 are held in a nonvolatile RAM (NVRAM) 215, which is a nonvolatile memory, and the settings are read from or written into the NVRAM 215 based on control programs.

The CPU 211 controls a scan unit 217 to scan a document, and stores scanned data in an image memory as a part of the RAM 214. The CPU 211 also controls a print unit 216 to print an image on a print medium based on image data held in the image memory, which is a part of the RAM 214.

The CPU 211 controls the USB communication unit 206 via a USB communication control unit 218 to perform USB communication with an external apparatus via a USB connection. The CPU 211 controls the wireless LAN communication unit 207 via a wireless LAN communication control unit 219 to perform wireless LAN communication with an external apparatus via an infrastructure connection or a direct connection. The CPU 211 controls the FAX communication unit 208 via a FAX communication control unit 220 to perform FAX communication with an external apparatus using a telephone line.

The CPU 211 controls an operation display control unit 221 to receive operation information from the operation display unit 201. Further, the CPU 211 controls the operation display control unit 221 to display a state of the image processing apparatus 200 and a function selection menu on the operation display unit 201.

FIG. 4 is a diagram schematically illustrating an example of a configuration of the operation display unit 201 of the image processing apparatus 200. The operation display unit 201 includes a plurality of buttons, a display, a light-emitting diode (LED), or the like. The configuration example illustrated in FIG. 4 indicates a case where a touch panel liquid crystal display 226 is adopted as the display of the operation display unit 201.

When the user presses a power button 222 in a state where power is supplied from the power supply unit 209, the image processing apparatus 200 is started. When the image processing apparatus 200 is started, a home screen, which is an uppermost hierarchical layer of a menu that can be operated by the user, is displayed on the touch panel liquid crystal display 226.

The home screen includes a copy area 231 for receiving a copy function execution instruction, a scan area 232 for receiving a scan function execution instruction, and a FAX area 233 for receiving a FAX function execution instruction. The home screen also includes a network area 234 for allowing the screen to transition to a menu for changing a network setting, such as an infrastructure connection or a direct connection of the image processing apparatus 200 or checking the state of the image processing apparatus 200. The home screen also includes a settings area 235 for allowing the screen to transition to a menu for executing other various functions, such as a setting change function and a setting reset function.

If the user needs to input a character string for password authentication or the like, a software keyboard may be displayed on the touch panel liquid crystal display 226 to receive an input from the user.

Pressing a home button 223 in a state where a screen of a menu hierarchical layer other than the home screen is displayed allows the screen to return to the home screen. Pressing a back button 224 in a state where a screen for a menu hierarchical layer other than the home screen is displayed allows the screen to return to the screen that is one level higher than the previous screen.

If various functions, such as a copy function and a scan function, are being executed and processing can be stopped at any timing, the processing being executed can be stopped by pressing a stop button 225.

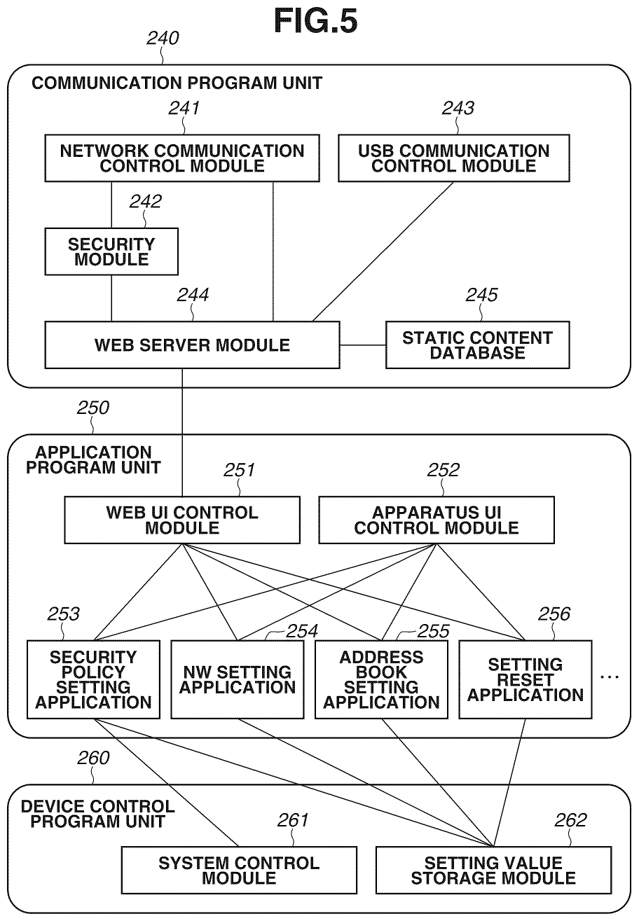

FIG. 5 is a block diagram conceptually illustrating a software configuration for implementing a setting change function and a setting reset function of software to operate on the image processing apparatus 200. Processing to be executed for the setting reset function is referred to as setting reset processing, or is simply referred to as reset processing. The elements and configurations of software illustrated in FIG. 5 are merely examples, and the elements and configurations of software according to the present exemplary embodiment are not limited to this example. The functions of the software group schematically illustrated in FIG. 5 are implemented by the CPU 211 operating based on control programs stored in the ROM 213 and part of data stored in the RAM 214 in association with the control programs.

The software group illustrated in FIG. 5 includes a communication program unit 240 for mainly controlling communication, an application program unit 250 for mainly controlling application functions, and a device control program unit 260 for mainly controlling lower layers in the image processing apparatus 200.

The communication program unit 240 includes a network communication control module 241, a security module 242, a USB communication control module 243, a web server module 244, and a static content database 245.

The network communication control module 241 is a module for controlling the wireless LAN communication control unit 219 to control layers up to a transport layer of a communication protocol stack, and implements Transmission Control Protocol (TCP)/Internet Protocol (IP) communication for the image processing apparatus 200.

The security module 242 is a module for performing communication encryption and decryption processing, and authentication and hash processing in association with the communication encryption and decryption processing, and the like, and implements Transport Layer Security/Secure Sockets Layer (TLS/SSL) communication for the image processing apparatus 200.

The USB communication control module 243 is a module for controlling the USB communication control unit 218 and performing an operation to behave as a USB device, and implements USB communication for the image processing apparatus 200.

The web server module 244 is a module for performing an operation for the image processing apparatus 200 to behave as a web server, and implements HTTP communication with the external terminal apparatus 300 on which a web browser operates. Specifically, the web server module 244 analyzes an HTTP request received from the external terminal apparatus 300, causes a web user interface (UI) control module 251 and the static content database 245 to operate based on a result of the analysis, forms generated data as an HTTP response, and transmits the HTTP response. The web server module 244 receives a request and transmits a response using TCP/IP communication, TLS/SSL communication, or USB communication.

The static content database 245 is a module that operates as a file system, and reads out Joint Photographic Experts Group (JPEG) data, Hyper Text Markup Language (HTML) data, or the like stored in the ROM 213 or the RAM 214.

The application program unit 250 includes the web UI control module 251, an apparatus UI control module 252, a security policy setting application 253, an NW setting application 254, an address book setting application 255, and a setting reset application 256 as application modules.

The web UI control module 251 generates data to display a web UI of the image processing apparatus 200 on the web browser of the external terminal apparatus 300 according to a request from the web server module 244. The web UI control module 251 obtains the operation state and setting state of the image processing apparatus 200 from each application module, generates data based on the obtained operation state and setting state, and returns the generated data, thereby making it possible to display the operation state and setting state of the image processing apparatus 200 on the web UI. The web UI displayed by the web browser of the terminal apparatus 300 is configured to issue an instruction to execute processing such as setting change processing or password authentication processing on the image processing apparatus 200.

When the user operates the web browser and issues an instruction to execute processing such as setting change processing or password authentication processing on the image processing apparatus 200 from the web UI, the image processing apparatus 200 receives the HTTP request including the content of the instruction. The web UI control module 251 receives the instruction via the web server module 244 and causes the corresponding application module to execute processing, such as setting change processing or password authentication processing, depending on the content of the instruction. After the processing is completed, the processing result indicating, for example, “successful” or “unsuccessful” is stored in the HTTP response to be transmitted.

The apparatus UI control module 252 controls the operation display control unit 221 to implement a UI in a main body of the image processing apparatus 200. The apparatus UI control module 252 stores menu hierarchical layer information and causes the touch panel liquid crystal display 226 to display an operation menu or the like corresponding to the current menu hierarchical layer. The apparatus UI control module 252 may obtain the operation state and setting state of the image processing apparatus 200 from each application module, may generate data based on the obtained operation state and setting state, and may cause the touch panel liquid crystal display 226 to display the generated data. Further, the apparatus UI control module 252 receives an operation, such as a setting change operation or a password authentication operation, from the operation display unit 201, and causes the corresponding application module to execute processing based on the operation. After the processing is completed, the apparatus UI control module 252 causes the touch panel liquid crystal display 226 to display the processing result indicating, for example, “successful” or “unsuccessful”.

The security policy setting application 253 receives an instruction from the web UI control module 251 or the apparatus UI control module 252, and performs security policy setting state obtaining processing or security policy setting change processing.

The NW setting application 254 receives an instruction from the web UI control module 251 or the apparatus UI control module 252, obtains an NW setting state, and performs NW setting change processing.

The address book setting application 255 receives an instruction from the web UI control module 251 or the apparatus UI control module 252, and performs processing of obtaining address book information, including FAX address information, processing of adding or deleting new address information to or from the address book information.

The setting reset application 256 receives an instruction from the web UI control module 251 or the apparatus UI control module 252, and performs processing of resetting each setting on the image processing apparatus 200.

The device control program unit 260 includes a system control module 261 and a setting value storage module 262.

The system control module 261 performs operations, including an operation of starting or stopping the image processing apparatus 200, to control an entire software system. In the present exemplary embodiment, the system control module 261 receives a restart request from the security policy setting application 253, and performs restart processing on the image processing apparatus 200.

The setting value storage module 262 operates to control processing, such as setting value storage processing, on the image processing apparatus 200. The setting value storage module 262 receives a setting value storage instruction from other modules, such as application modules, and writes setting values into the NVRAM 215. The setting value storage module 262 receives a setting value reference instruction from other modules, such as application modules, and reads out setting values from the NVRAM 215.

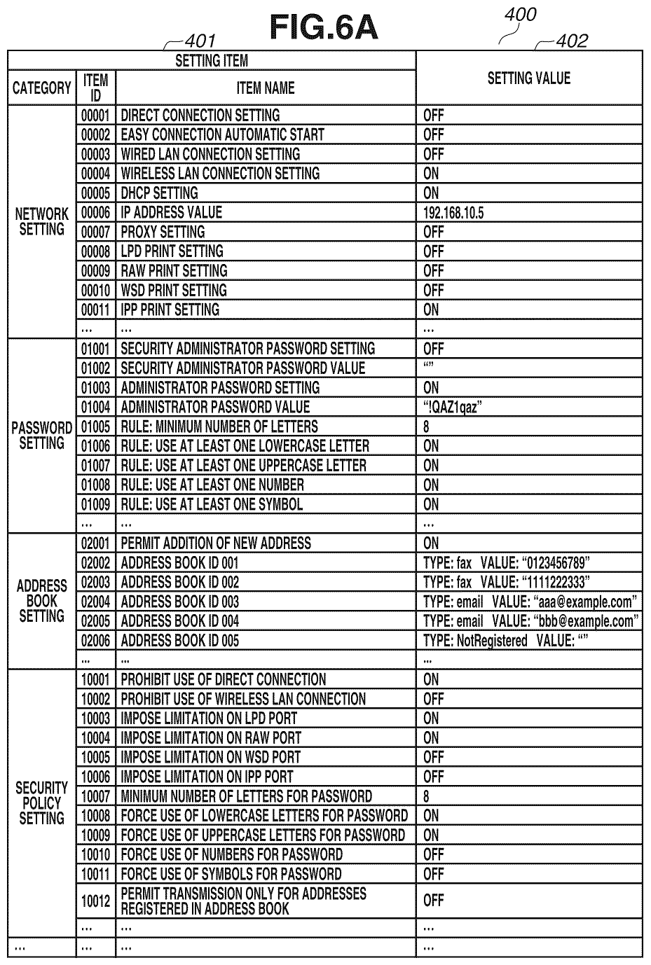

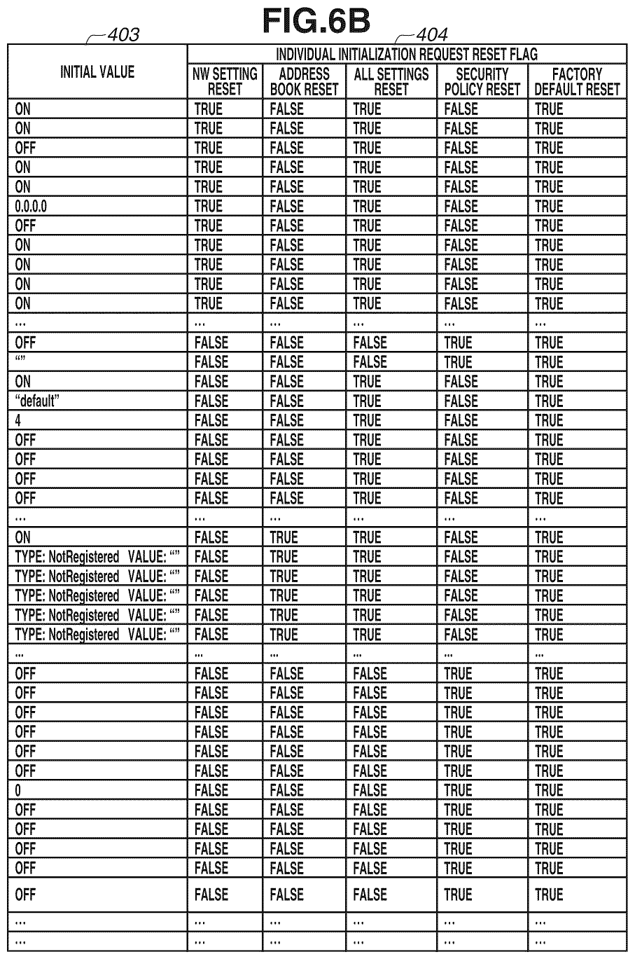

FIGS. 6A and 6B are diagrams schematically illustrating an example of setting item management information about the image processing apparatus 200.

FIGS. 6A and 6B schematically illustrate an example of a part of information representing setting values for setting items stored in the NVRAM 215 via the setting value storage module 262 and management information about the setting values as setting item management information 400.

As indicated by a column 401, all setting items can be uniquely identified by an item identification (ID) and setting values can be written or read out by designating the item ID.

A column 402 indicates a current setting value for each setting item.

A column 403 is a factory default setting value for each setting item. When each setting reset function to be described below is executed, setting items to be reset by the setting reset function are set to factory default values indicated by the column 403.

A column 404 indicates an individual initialization request reset flag representing whether an individual setting item is a target item to be reset by each setting reset function when the setting reset function is executed. The individual initialization request reset flag “TRUE” indicates that the setting item is the target item to be reset by the setting reset function, and the individual initialization request reset flag “FALSE” indicates that the setting item is not the target item to be reset by the setting reset function.

Examples of the setting reset functions include an NW setting reset function, an address book reset function, an all settings reset function, a security policy reset function, and a factory default reset function. Resetting a setting value to an initial value is hereinafter expressed using the terms “to reset” and “resetting”.

In the NW setting reset function, a setting for enabling or disabling an infrastructure connection or a direct connection, a setting for each communication protocol, and the like are reset.

In the address book reset function, address book information, including address information or the like to be used in the FAX function, is reset.

In the all settings reset function, setting items other than the security policy setting item in the setting items of the image processing apparatus 200 that can be changed by the user are reset.

In the security policy reset function, a setting related to a security administrator password and a security policy setting are reset. The term “security administrator password” as used herein refers to a password for protecting a security policy setting not to be changed by a third person. When the user sets a security administrator password value, the security administrator password setting is set to “ON”. In this case, authentication processing using this password is required in a security policy setting operation, a security policy reset operation, and the like.

In the factory default reset function, all setting items that can be reset among the setting items of the image processing apparatus 200 are forcibly reset. The factory default reset processing is special processing for production, repair, service, and the like of the image processing apparatus 200, and can be executed only when a special key entry or a special external tool is used.

While FIGS. 6A and 6B illustrate an example of the setting item management information 400 in a tabular format, the format for holding this information in the image processing apparatus 200 is not limited to this example. For example, this information may be held in a specific database format, or may be held in a JavaScript Object Notation (JSON) file format or the like. Alternatively, only setting values indicated by the column 402 may be held in the RAM 214 or the NVRAM 215, and other information may be represented as a program stored in the ROM 213.

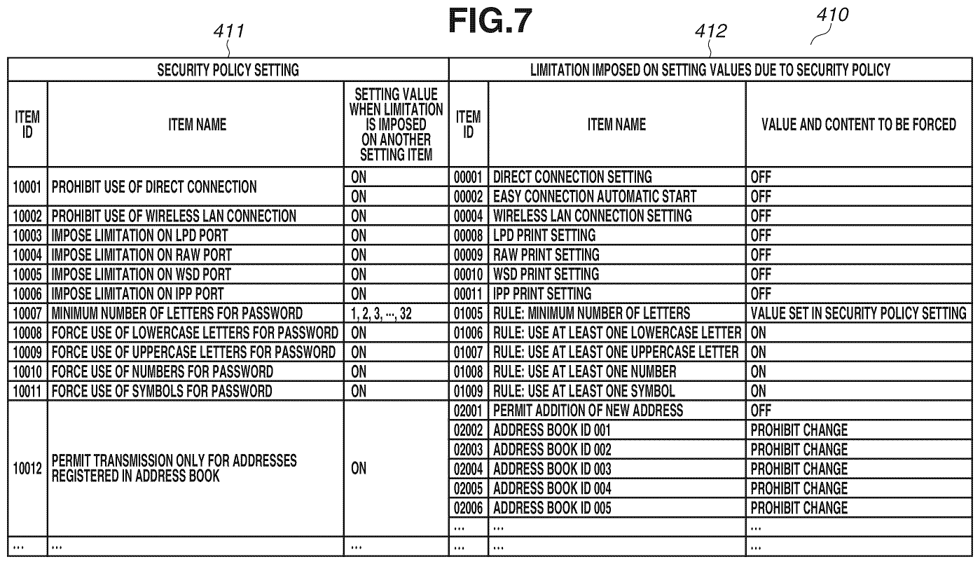

FIG. 7 is a diagram schematically illustrating a dependency relationship between the security policy setting, which is managed and controlled by the security policy setting application 253 of the image processing apparatus 200, and other settings. The term “dependency relationship” as used herein means that the content of a setting value of a dependency source affects the content of a setting value of a dependency destination.

A column 411 indicates a setting item for the security policy setting of the dependency source, and a condition on which the dependency relationship occurs.

A column 412 indicates the setting item of the dependency destination, and also indicates how the setting value is forcibly set when the dependency relationship occurs.

For example, in a security policy setting “prohibit use of direct connection” indicated by an item ID “10001”, the setting value in the setting item affects the setting value of the dependency destination when the setting value indicates “ON”. In this case, the setting value for “direct connection setting” indicated by an item ID “00001” is forcibly set to “OFF”, and the setting value for “easy connection automatic start” indicated by an item ID “00002” is forcibly set to “OFF”.

In a security policy setting “minimum number of letters for password” indicated by an item ID “10007”, the setting value in the setting item affects the setting value of the dependency destination when the setting value in the setting item is in a range of integers from “1” to “32”. In this case, “rule: minimum number of letters” indicated by an item ID “01005” is forcibly set to the same value as the setting value set in the security policy setting “minimum number of letters for password”.

In a security policy setting “permit transmission only for addresses registered in address book” indicated by an item ID “10012”, the setting value in the setting item affects the setting value of the dependency destination when the setting value indicates “ON”. In this case, the setting value for “permit addition of new address” indicated by an item ID “02001” is forcibly set to “OFF”, and change of the setting value for address book information described in the row of an item ID “02002” and subsequent rows is prohibited.

While FIG. 7 illustrates an example of a dependency relationship 410 between the security policy setting and other settings in a tabular format, the format for holding this information in the image processing apparatus 200 is not limited to this example. For example, this information may be held in a specific database format, a JSON file format, or the like, or may be represented as a program stored in the ROM 213.

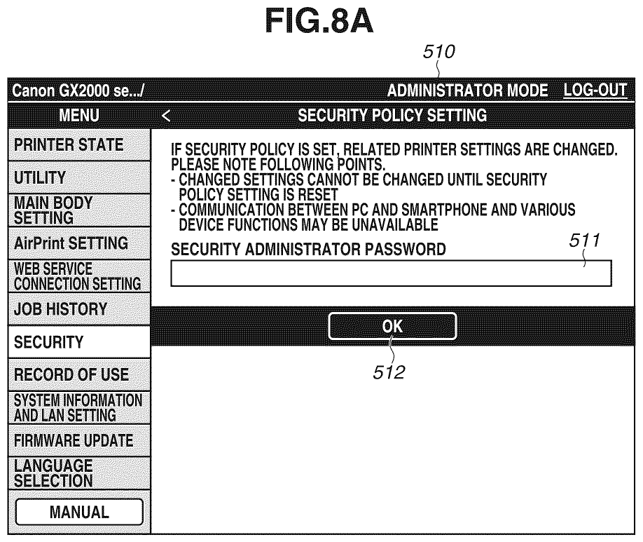

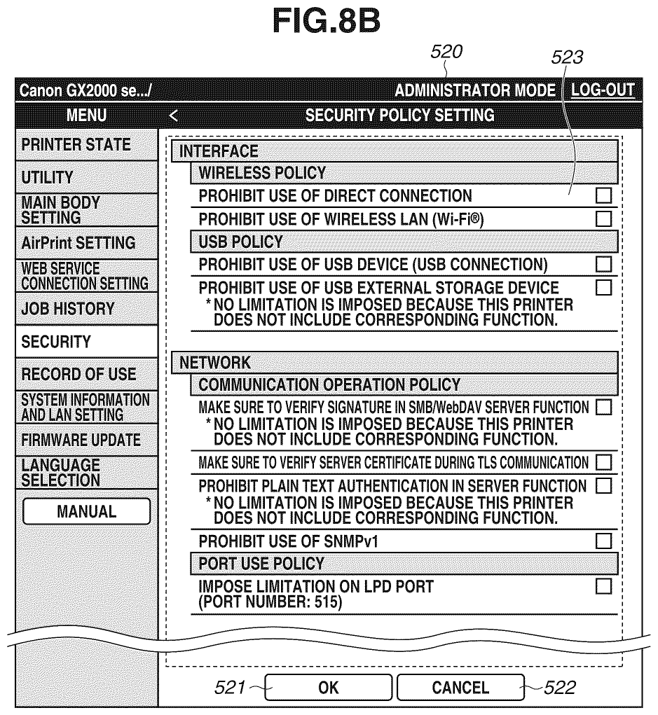

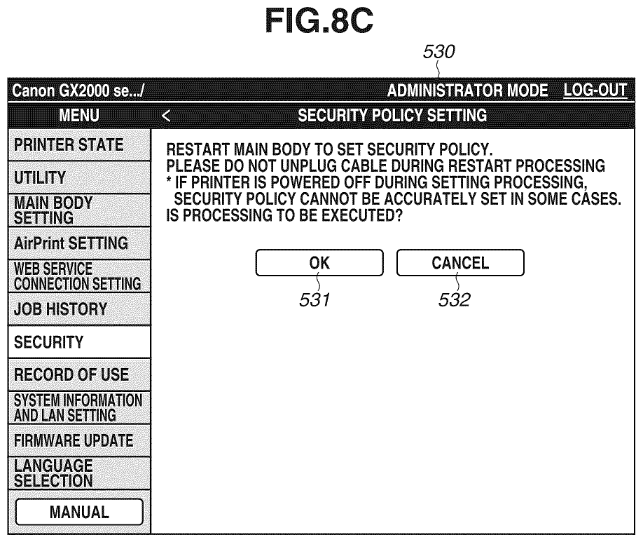

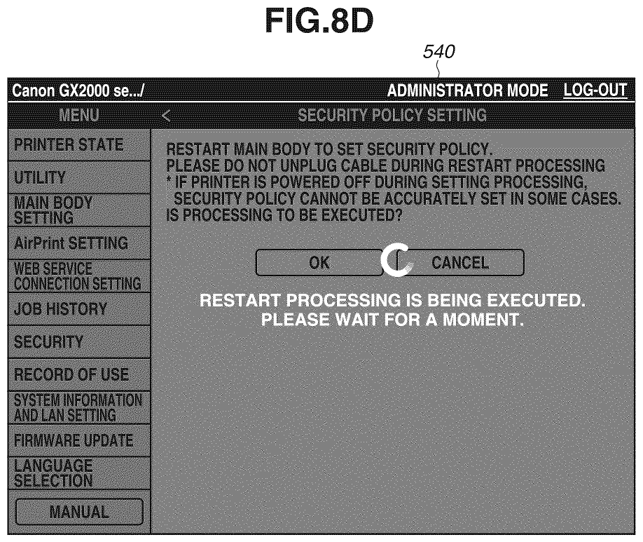

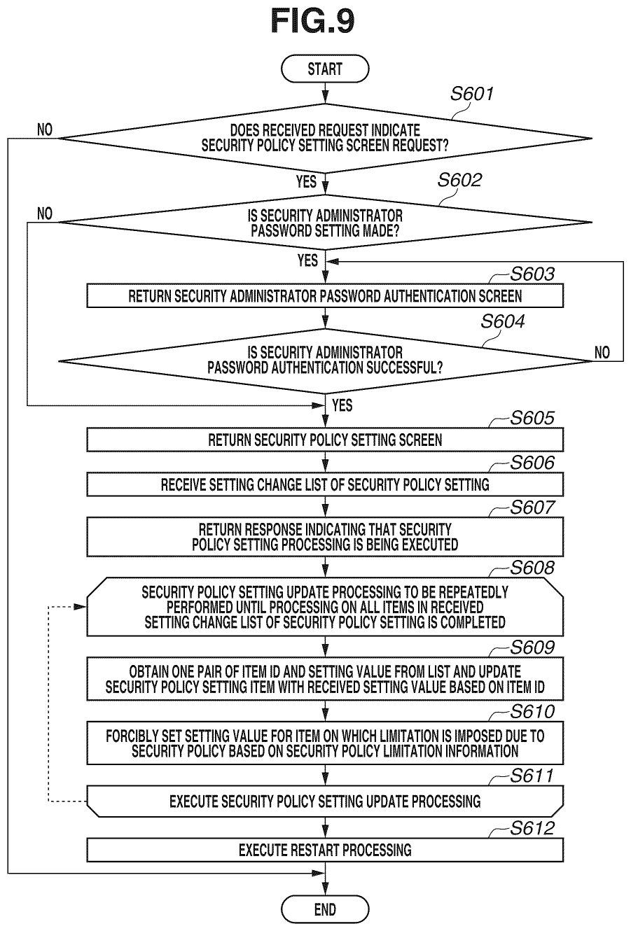

Next, processing to be performed when a security policy setting is made from the web UI will be described with reference to FIGS. 8A to 8D and FIG. 9.

FIGS. 8A to 8D each illustrate an example of a screen to be displayed by the web browser of the terminal apparatus 300 during the security policy setting according to the present exemplary embodiment.

FIG. 9 is a flowchart illustrating an example of security policy setting processing to be performed by the image processing apparatus 200 according to the present exemplary embodiment. Processing of each step illustrated in FIG. 9 is implemented by the CPU 211 executing programs stored in the ROM 213. The processing in the flowchart illustrated in FIG. 9 is started when the web server module 244 of the image processing apparatus 200 receives an HTTP request from the web browser of the terminal apparatus 300.

In step S601, the web server module 244 determines whether the received HTTP request indicates a security policy setting screen request. The determination as to whether the received request indicates the security policy setting screen display request is made based on a requested uniform resource locator (URL) or a request parameter.

If the web server module 244 determines that the received HTTP request does not indicate the security policy setting screen request (NO in step S601), the processing in this flowchart ends. In practice, an image processing apparatus is configured to receive any request other than the security policy setting screen request, and thus continuously checks whether other requests can be received and performs processing in response to the requests. However, this processing deviates from the intent of the present disclosure, and thus the description thereof is omitted.

On the other hand, if the web server module 244 determines that the received HTTP request indicates the security policy setting screen request (YES in step S601), the web server module 244 requests the web UI control module 251 to generate a security policy setting screen. Then, the processing proceeds to step S602.

In step S602, the web UI control module 251 determines whether the security administrator password setting is made. Specifically, the web UI control module 251 obtains the setting value for the security administrator password setting from the NVRAM 215 via the security policy setting application 253 and the setting value storage module 262. If the obtained setting value indicates “ON”, it is determined that the security administrator password is set.

If the web UI control module 251 determines that the security administrator password setting is not made (NO in step S602), the processing proceeds to step S605.

On the other hand, if the web UI control module 251 determines that the security administrator password setting is made (YES in step S602), the processing proceeds to step S603.

In step S603, the web UI control module 251 generates a security administrator password authentication screen, and returns the security administrator password authentication screen as illustrated in FIG. 8A to the terminal apparatus 300 via the web server module 244.

FIG. 8A illustrates an example of a screen 510 to be displayed when the web browser of the terminal apparatus 300 receives the security administrator password authentication screen from the image processing apparatus 200. An entry field 511 is a security administrator password entry field. An OK button 512 is a button for performing authentication processing using the security administrator password. When the user inputs the security administrator password into the entry field 511 and clicks the OK button 512, information about the input security administrator password is transmitted to the image processing apparatus 200.

Upon receiving the information about the security administrator password via the web server module 244, the web UI control module 251 causes an unillustrated application module associated with password authentication to execute password authentication processing. This application module determines whether the received security administrator password authentication is successful or unsuccessful. Specifically, the image processing apparatus 200 receives the information about the security administrator password transmitted from the terminal apparatus 300, compares the received information about the security administrator password with a “security administrator password value” stored in the NVRAM 215, and determines whether the received information about the security administrator password matches the “security administrator password value”. If the received information about the security administrator password does not match the “security administrator password value”, it is determined that the security administrator password authentication is unsuccessful. This application module returns information indicating whether the security administrator password authentication is successful or unsuccessful to the web UI control module 251.

The description will now return to the flowchart illustrated in FIG. 9.

In step S604, the web UI control module 251 determines whether the security administrator password authentication is successful. If the web UI control module 251 determines that the security administrator password authentication is unsuccessful (NO in step S604), the processing returns to step S603 and the web UI control module 251 returns the security administrator password authentication screen to the web browser of the terminal apparatus 300 again to prompt the user to input the password again.

On the other hand, if the web UI control module 251 determines that the security administrator password authentication is successful (YES in step S604), the processing proceeds to step S605.

In step S605, the web UI control module 251 generates a security policy setting screen as illustrated in FIG. 8B, and returns the security policy setting screen to the terminal apparatus 300 via the web server module 244.

FIG. 8B illustrates an example of a screen 520 to be displayed when the web browser of the terminal apparatus 300 receives the security policy setting screen from the image processing apparatus 200.

An OK button 521 is a button for confirming and finalizing a setting change in the security policy setting. When the user presses the OK button 521, a setting change list for security policy setting (hereinafter referred to as a “setting change list”) operated on the screen 520 is temporarily stored in the web browser, and then the screen transitions to a screen illustrated in FIG. 8C.

A cancel button 522 is a button for cancelling the security policy setting. When the user presses the cancel button 522, the HTTP request for requesting a menu screen that is one level higher than the security policy setting menu is transmitted from the web browser. The image processing apparatus 200 generates data on the requested screen and returns the generated data, and the processing in the flowchart illustrated in FIG. 9 ends (not illustrated).

An area 523 is an area where various setting items on the security policy are displayed together with a checkbox for enabling each setting, a text box, and the like. The user that operates the web browser of the terminal apparatus 300 can change the security policy setting on the image processing apparatus 200 by operating the checkbox, the text box, or the like.

FIG. 8C illustrates an example of a security policy setting execution confirmation screen 530.

A cancel button 532 is a button for cancelling transmission of the setting change list.

When the user presses the cancel button 532, the web browser displays the screen 520 again. In this case, the web browser reads out the setting change list temporarily stored, and displays the setting change list in a state where the setting change list is applied to the checkbox, the textbox, and the like in the area 523.

An OK button 531 is a button for transmitting the setting change list. When the user presses the OK button 531, the HTTP request including the setting change list temporarily stored in the web browser is transmitted to the image processing apparatus 200. The “setting change list” as used herein refers to information in a list form including a combination of a value for each item ID and a changed setting value for the item in each row included in the category “security policy setting” in the column 401 illustrated in FIG. 6A.

The description will now return to the flowchart illustrated in FIG. 9.

After the web UI control module 251 receives the HTTP request including the setting change list via the web server module 244, the processing proceeds to step S606.

In step S606, the web UI control module 251 starts security policy setting change processing. Specifically, upon receiving the setting change list via the web server module 244, the web UI control module 251 generates response data indicating that the security policy setting processing is being executed.

Next, in step S607, the web UI control module 251 returns the HTTP response including the response data (screen as illustrated in FIG. 8D) indicating that the security policy setting processing is being executed to the terminal apparatus 300 via the web server module 244. Further, the web UI control module 251 transmits the received setting change list to the security policy setting application 253, and then the processing proceeds to step S608.

FIG. 8D illustrates an example of a screen 540 to be displayed when the web browser of the terminal apparatus 300 receives, from the image processing apparatus 200, the response data indicating that the security policy setting processing is being executed.

The screen 540 operates not to receive a user operation. An inquiry about whether the security policy setting processing is completed is periodically made in background processing of the web browser, and when the processing is completed, the screen 540 operates to display a top screen for the web UI of the image processing apparatus 200 (not illustrated).

The description will now return to the flowchart illustrated in FIG. 9, again.

The security policy setting application 253 that has received the received setting change list executes processing of steps S608 to S611 repeatedly. The processing is repeatedly performed until the processing on all items in the received setting change list is completed.

In the repetitive processing described above, in step S609, the security policy setting application 253 first obtains one pair of an item ID and a setting value on which the repetitive processing is not performed yet from the setting change list. Then, the security policy setting application 253 stores the changed setting on the obtained pair in the NVRAM 215 via the setting value storage module 262. In this case, the setting value is stored based on the corresponding item ID. Accordingly, a designated item in the security policy setting can be updated.

Next, in step S610, the security policy setting application 253 performs setting value limitation processing based on the dependency relationship 410 between the security policy setting and other settings illustrated in FIG. 7. Specifically, the security policy setting application 253 checks the row that matches the currently stored setting item ID for the security policy in the column 411, and checks whether the stored setting value matches a “setting value when a limitation is imposed on another setting item”. If the stored setting value matches the “setting value when a limitation is imposed on another setting item”, the setting value for the setting item of the dependency destination is forcibly set as indicated by the column 412. For example, if the changed setting on the obtained pair indicates that the setting value for the item ID “10001” is “ON”, “OFF” is stored as the setting value for the item ID “00001” and “OFF” is stored as the setting value for the item ID “00002” in the NVRAM 215 via the setting value storage module 262.

Next, in step S611, if the security policy setting application 253 determines that the setting change list includes one or more pairs that are not processed yet, the processing returns to step S608. If the setting change list includes no pair that is not processed yet, the processing proceeds to step S612.

In step S612, the security policy setting application 253 requests the system control module 261 to restart the image processing apparatus 200. Upon receiving this request, the system control module 261 executes restart processing, and the processing in this flowchart ends.

The processing to be performed when the security policy setting is made from the web UI as described above with reference to FIGS. 8A to 8D and FIG. 9 may be performed from an apparatus UI. In this case, the processing is mainly controlled by the apparatus UI control module 252.

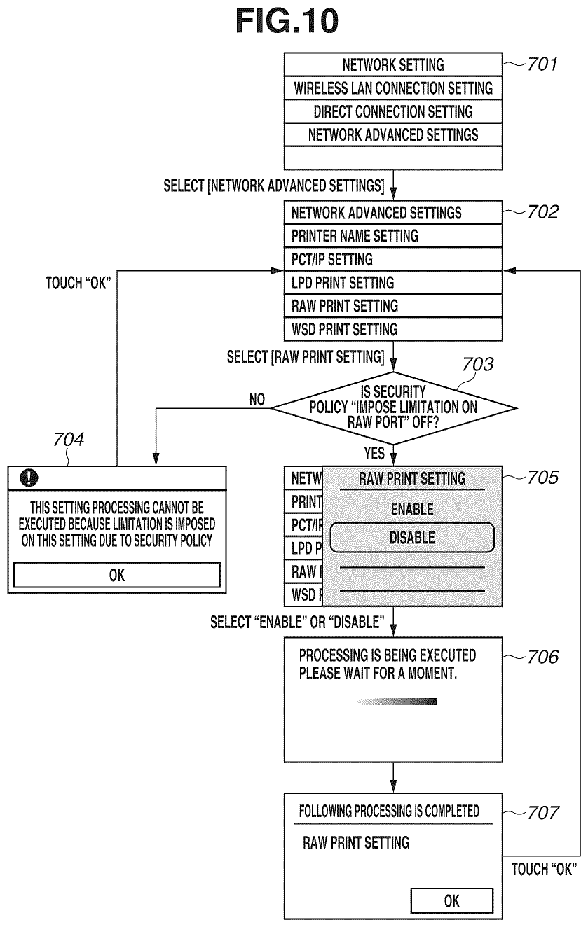

FIG. 10 illustrates a screen flow when a RAW print setting is operated and displayed, as an example of how to impose a limitation on a UI operation of the image processing apparatus 200 by the security policy setting. The screen flow illustrated in FIG. 10 is implemented by the CPU 211 executing programs stored in the ROM 213, and is mainly controlled by the apparatus UI control module 252.

A screen 701 is a network setting menu screen to be displayed when a user touches the network area 234 in a state where the home screen is displayed on the touch panel liquid crystal display 226 of the image processing apparatus 200. When the user touches “network advanced settings” on this screen, the screen transitions to a screen 702.

Next, when the user touches “RAW print setting” on the screen 702, the screen flow proceeds to a determination 703.

In the determination 703, the apparatus UI control module 252 obtains the setting value for “impose a limitation on RAW port” corresponding to an item ID “10004” via the security policy setting application 253 and the setting value storage module 262. If the obtained value indicates “ON” (NO in the determination 703), the screen transitions to a screen 704. If the obtained value indicates “OFF” (YES in the determination 703), the screen transitions to a screen 705.

On the screen 704, a notification indicating that a limitation is imposed on the setting change of the RAW print setting by the security policy setting is issued to the user. When an OK button on the screen 704 is pressed, the screen returns to the screen 702.

Options for the RAW print setting are displayed on the screen 705. In the example of the screen, when the user touches either one of “enable” and “disable”, the screen transitions to a screen 706.

On the screen 706, a message for notifying the user that setting change processing is being executed is displayed, and setting change processing is executed on the image processing apparatus 200. For example, if “enable” is touched on the screen 705, the apparatus UI control module 252 changes the setting value for “RAW print setting” corresponding to an item ID “00009” to “ON” via the NW setting application 254 and the setting value storage module 262. On the other hand, if “disable” is touched on the screen 705, the apparatus UI control module 252 changes the setting value for “RAW print setting” corresponding to the item ID “00009” to “OFF”.

If the setting change processing on “RAW print setting” is completed, the screen transitions to a screen 707 to notify the user that the setting change processing is completed. When the user touches an OK button on this screen, the screen returns to the screen 702.

While FIG. 10 illustrates an example where setting change processing is performed by a UI operation on the main body of the image processing apparatus 200, the method of setting change processing is not limited to this example. For example, the setting change processing may be implemented using a web UI. In this case, a setting change procedure and setting change limitation processing similar to those in the screen flow described above with reference to FIG. 10 can be performed. In this case, the processing is mainly controlled by the web UI control module 251.

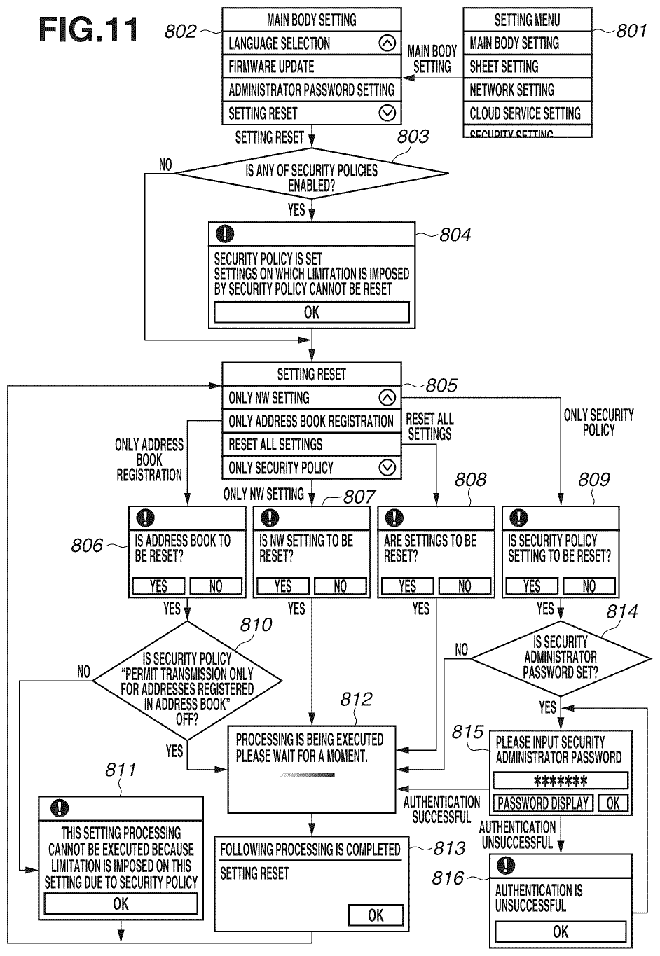

The setting reset functions of the image processing apparatus 200 will be described below with reference to FIGS. 11, 12, and 13. Processing in processing flows illustrated in FIGS. 11, 12, and 13 is implemented by the CPU 211 executing programs stored in the ROM 213, and is mainly controlled by the apparatus UI control module 252.

FIG. 11 illustrates a screen flow for resetting various setting values stored in the NVRAM 215 by a UI operation on the main body of the image processing apparatus 200 according to the first exemplary embodiment.

A screen 801 is a setting menu screen to be displayed when the user touches the settings area 235 in a state where the home screen is displayed on the touch panel liquid crystal display 226 of the image processing apparatus 200. When the user touches “main body setting” on this screen, the screen transitions to a screen 802.

Next, when the user touches “setting reset” on the screen 802, the screen flow proceeds to a determination 803.

In the determination 803, the apparatus UI control module 252 checks with the security policy setting application 253 whether any of the security policy settings is enabled.

The security policy setting application 253 obtains the security administrator password setting and the security policy setting stored in the NVRAM 215 via the setting value storage module 262, and determines whether any of the security policy settings is enabled. Specifically, the setting value for “security administrator password setting” corresponding to an item ID “01001” and values in the items of the security policy setting starting from the item ID “10001” are obtained from the NVRAM 215. If any of the obtained values indicates a value other than “0” and “OFF”, it is determined that any of the security policy settings is enabled (set).

If any of the security policy settings is enabled (YES in the determination 803), the screen transitions to a screen 804. If none of the security policy settings is enabled (NO in the determination 803), the screen transitions to a screen 805.

The screen 804 provides the user with a notification that setting items having a dependency relationship with each item of the security policy setting cannot be reset in some cases due to the setting of the security policy. When the user touches an OK button on this screen, the screen transitions to the screen 805.

A menu for various setting reset functions is displayed on the screen 805.

In this case, when the user touches “only address book registration”, the screen transitions to a screen 806.

When the user touches “only NW setting”, the screen transitions to a screen 807.

When the user touches “reset all settings”, the screen transitions to a screen 808.

When the user touches “only security policy”, the screen transitions to a screen 809.

First, a transition of the screen when “only address book registration” is touched will be described.

The screen 806 is a screen for checking whether to execute address book reset processing. If the user touches a “YES” button on this screen, the screen flow proceeds to a determination 810. If the user touches a “NO” button on this screen, the screen transitions to the screen 805.

In the determination 810, the apparatus UI control module 252 obtains the setting value for “permit transmission only for addresses registered in address book” corresponding to the item ID “10012” via the security policy setting application 253 and the setting value storage module 262. If the obtained value indicates “ON” (NO in the determination 810), the screen transitions to a screen 811. If the obtained value indicates “OFF” (YES in the determination 810), the screen transitions to a screen 812.

The screen 811 provides the user with a notification that a limitation is imposed on the address book reset processing by the security policy setting. When the user touches an OK button on the screen 811, the screen returns to the screen 805. This is processing for prohibiting the change of address book information, such as the item ID “02002”, when the setting value for “permit transmission only for addresses registered in address book” corresponding to the item ID “10012” indicates “ON”.

If the screen transitions from the screen 806 to the screen 812, the apparatus UI control module 252 requests the setting reset application 256 to perform address book reset processing. Upon receiving the address book reset processing request, the setting reset application 256 executes change setting processing based on the initial value indicated by the column 403 and the individual initialization request reset flag indicated by the column 404 in the setting item management information 400. Specifically, items indicated by the individual initialization request reset flag “TRUE” in an “address book reset” column in the column 404 are extracted, and the area of the NVRAM 215 associated with the item ID is changed to the value in an “initial value” column for each extracted item via the setting value storage module 262. After the address book reset processing is completed, the screen transitions to a screen 813. The screen 813 provides the user with a notification that the reset processing is completed.

Specifically, if the address book initialization (address book reset) is selected, the image processing apparatus 200 does not initialize (reset) the address book setting when the setting for the security policy “permit transmission only for addresses registered in address book” is enabled (ON). On the other hand, if the setting for the security policy “permit transmission only for addresses registered in address book” is disabled (OFF), the address book setting is initialized.

Next, a case where “only NW setting” is touched will be described. In this case, the screen transitions to the screen 807.

The screen 807 is a screen for checking whether to execute NW setting reset processing. When the user touches a “YES” button, the screen transitions to the screen 812. When the user touches a “NO” button, the screen transitions to the screen 805.

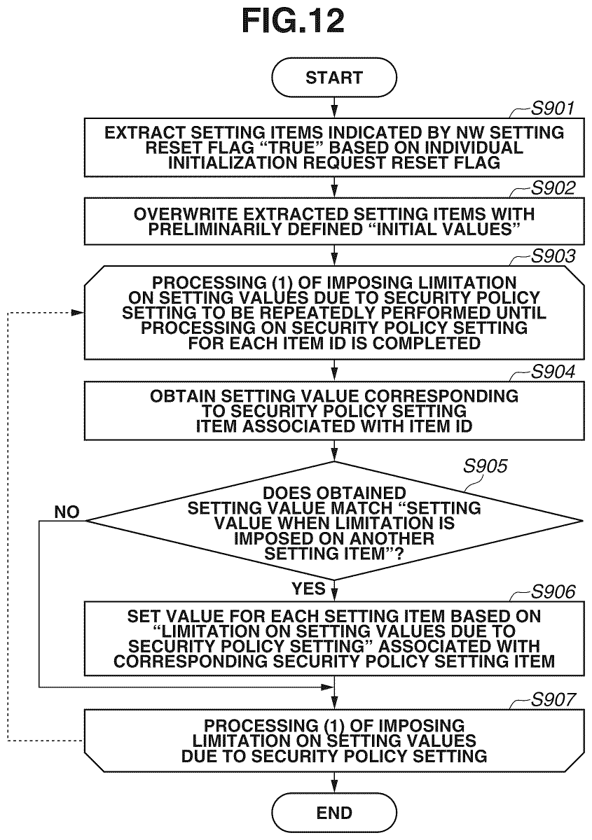

If the screen transitions from the screen 807 to the screen 812, the apparatus UI control module 252 requests the setting reset application 256 to perform NW setting reset processing. The NW setting reset processing to be performed by the setting reset application 256 will be described below with reference to FIG. 12. After the NW setting reset processing is completed, the screen transitions to the screen 813.

Next, a case where “reset all settings” is touched will be described. In this case, the screen transitions to the screen 808.

The screen 808 is a screen for checking whether to execute all settings reset processing. When the user touches a “YES” button, the screen transitions to the screen 812. When the user touches a “NO” button, the screen transitions to the screen 805.

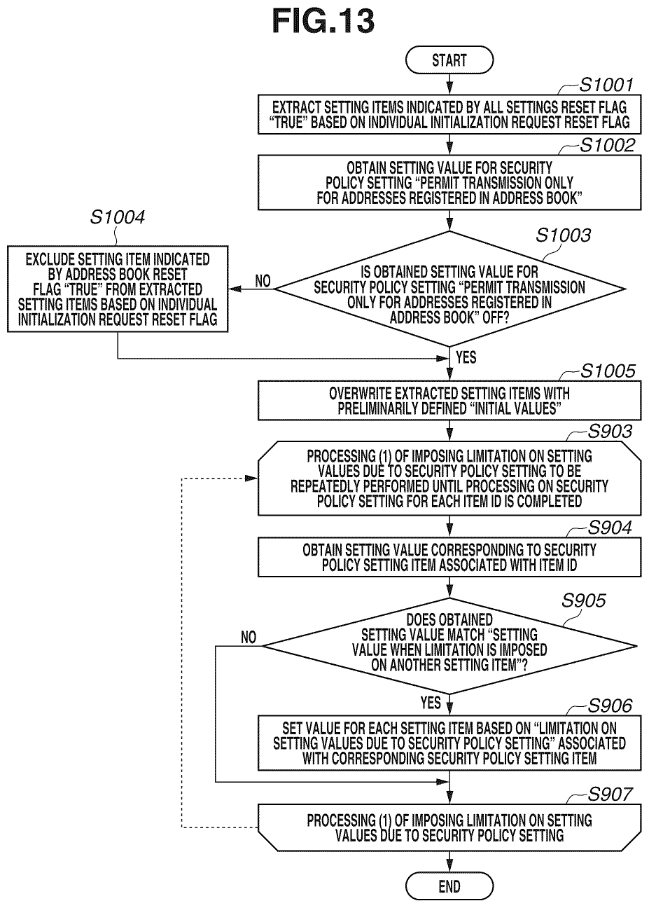

If the screen transitions from the screen 808 to the screen 812, the apparatus UI control module 252 requests the setting reset application 256 to perform all settings reset processing. The all settings reset processing to be performed by the setting reset application 256 will be described below with reference to FIG. 13. After the all settings reset processing is completed, the screen transitions to the screen 813.

Next, a case where “only security policy” is touched will be described. In this case, the screen transitions to the screen 809.

The screen 809 is a screen for checking whether to execute security policy reset processing. When the user touches a “YES” button, the screen flow proceeds to a determination 814. When the user touches a “NO” button, the screen transitions to the screen 805.

In the determination 814, the apparatus UI control module 252 obtains the setting value for “security administrator password setting” corresponding to the item ID “01001” via the security policy setting application 253 and the setting value storage module 262. If the obtained value indicates “OFF” (NO in the determination 814), the screen transitions to the screen 812. If the obtained value indicates “ON” (YES in the determination 814), the screen transitions to a screen 815.

The screen 815 is a screen for performing authentication processing using the security administrator password. The screen 815 includes a security administrator password entry field. When the user touches the entry field, a software keyboard is displayed to prompt the user to input the security administrator password.

When the user inputs the security administrator password and touches an OK button, the apparatus UI control module 252 obtains the input information and requests the security policy setting application 253 to authenticate the security administrator password. The security policy setting application 253 compares the obtained information about the security administrator password input by the user with the “security administrator password value” stored in the NVRAM 215, and determines whether the obtained security administrator password matches the “security administrator password value”. If the obtained security administrator password does not match the “security administrator password value”, the security policy setting application 253 determines that the security administrator password authentication is unsuccessful. If the obtained security administrator password matches the “security administrator password value”, the security policy setting application 253 determines that the security administrator password authentication is successful. If the security administrator password authentication is unsuccessful, the screen transitions to a screen 816 and the apparatus UI control module 252 notifies the user that the security administrator password authentication is unsuccessful. If the user touches an OK button on this screen, the screen 815 is displayed again to prompt the user to input the security administrator password. On the other hand, if the apparatus UI control module 252 determines that the security administrator password authentication is successful, the screen transitions to the screen 812.

If the screen transitions from the screen 809 or the screen 815 to the screen 812, the apparatus UI control module 252 requests the setting reset application 256 to perform security policy reset processing. Upon receiving the security policy reset processing request, the setting reset application 256 performs setting change processing based on the initial value indicated by the column 403 and the individual initialization request reset flag indicated by the column 404 in the setting item management information 400. Specifically, items indicated by the individual initialization request reset flag “TRUE” in a “security policy reset” column in the column 404 are extracted, and the area of the NVRAM 215 associated with the item ID is changed to the value in the “initial value” column for each extracted item via the setting value storage module 262. Although not illustrated, the security policy setting application 253 forcibly sets the setting value for the setting item on which a limitation is imposed by the security policy to the value that complies with the limitation. After the security policy reset processing is completed, the screen transitions to the screen 813.

The screen 813 is a screen indicating that various reset processing is completed. When the user touches an OK button on this screen, the screen transitions to the screen 805.

Next, NW setting reset processing to be performed by the setting reset application 256 will be described with reference to a flowchart illustrated in FIG. 12.

FIG. 12 is a flowchart illustrating NW setting reset processing to be performed by the image processing apparatus according to the first exemplary embodiment. The processing in this flowchart is started when the setting reset application 256 receives an NW setting reset processing request.

In steps S901 and S902, the setting reset application 256 performs setting change processing based on the initial value indicated by the column 403 and the individual initialization request reset flag indicated by the column 404 in the setting item management information 400. Specifically, in step S901, the setting reset application 256 extracts items indicated by the individual initialization request reset flag “TRUE” in an “NW setting reset” column in the column 404. In step S902, the setting reset application 256 changes the area of the NVRAM 215 associated with the item ID to the value in the “initial value” column for each extracted item via the setting value storage module 262.

Next, the setting reset application 256 executes repetitive processing of steps S903 to S907. This repetitive processing is repeatedly performed for each item ID until the processing on all items in the security policy setting is completed. Specifically, the processing may be performed in order from “prohibit use of direct connection” corresponding to the item ID “10001” and the item ID as the processing target may be incremented every time the processing is repeated. When the processing on all item IDs within the range of the security policy setting is completed, the repetitive processing ends, and the processing is completed.

In step S904, the setting reset application 256 obtains the setting value associated with each item ID for the security policy setting as the processing target from the NVRAM 215 via the setting value storage module 262.

Next, in step S905, the setting reset application 256 checks whether the setting value obtained in step S904 described above matches the “setting value when a limitation is imposed on another setting item” in the row of the processing target item ID among the dependency sources indicated by the dependency relationship 410 between the security policy setting and other settings. If the setting reset application 256 determines that the obtained setting value does not match the “setting value when a limitation is imposed on another setting item” (NO in step S905), the processing proceeds to step S907.

On the other hand, if the setting reset application 256 determines that the obtained setting value matches the “setting value when a limitation is imposed on another setting item” (YES in step S905), the processing proceeds to step S906.

In step S906, the setting reset application 256 forcibly sets the setting value for each setting item dependent on the processing target item ID to the setting value that complies with the limitation imposed by the security policy indicated by the column 412.

For example, assume a case where the processing target is the item ID “10001” and the setting value for the item ID “10001” indicates “ON”. In this case, “OFF” is stored as the setting value for the item ID “00001” and “OFF” is stored as the setting value for the item ID “00002” in the NVRAM 215 via the setting value storage module 262.

Assume a case where the processing target is the item ID “10007” and the setting value for the item ID “10007” is “10”. In this case, “10” is stored as the setting value for the item ID “01005” in the NVRAM 215 via the setting value storage module 262.

Also, assume a case where the processing target is the item ID “10012” and the setting value for the item ID “10012” indicates “ON”. In this case, “OFF” is stored as the setting value for the item ID “02001” in the NVRAM 215 via the setting value storage module 262, and setting values for each address book information associated with the item ID “02002” and subsequent item IDs are not changed.

After the processing of step S906, the processing proceeds to step S907.

If the setting reset application 256 determines that there is an item ID on which the security policy setting processing is not performed yet, the processing returns to step S903. If the setting reset application 256 determines that there is no item ID on which the security policy setting processing is not performed yet (NO in step S907), the processing in this flowchart ends.

Specifically, if network setting initialization (NW setting reset) is selected, the image processing apparatus 200 initializes the network setting (steps S901 and S902) and performs setting processing on the setting on which a limitation is imposed by the security policy in compliance with the limitation (steps S903 to S907).

The above-described processing makes it possible to maintain the limitation on the setting value imposed by the security policy setting in the NW setting reset processing. Further, the number of comparison and checking operations in the method according to the present exemplary embodiment is smaller than that in the method of checking whether a limitation is imposed in the security policy setting on all NW setting items for the image processing apparatus 200, which leads to a reduction in processing load and waiting time for the user.

Next, all settings reset processing to be performed by the setting reset application 256 will be described with reference to a flowchart illustrated in FIG. 13.

FIG. 13 is a flowchart illustrating all settings reset processing to be performed by the image processing apparatus 200 according to the first exemplary embodiment. The processing in this flowchart is started when the setting reset application 256 receives an all settings reset processing request.

In steps S1001 to S1005, the setting reset application 256 performs setting change processing based on the initial value indicated by the column 403 and the individual initialization request reset flag indicated by the column 404 in the setting item management information 400.

Specifically, in step S1001, the setting reset application 256 extracts items indicated by the individual initialization request reset flag “TRUE” in an “all settings reset” column in the column 404.

In step S1002, the setting reset application 256 obtains the setting value for “permit transmission only for addresses registered in address book” corresponding to the item ID “10012” via the setting value storage module 262.

Next, in step S1003, the setting reset application 256 determines whether the value obtained in step S1002 described above indicates “OFF”. If the obtained value indicates “OFF” (YES in step S1003), the processing proceeds to step S1005. If the value indicates “ON” (NO in step S1003), the processing proceeds to step S1004.

In step S1004, the setting reset application 256 excludes setting items indicated by an address book reset flag “TRUE” from the items extracted in step S1001 described above based on the individual initialization request reset flag, and then the processing proceeds to step S1005.

In step S1005, the setting reset application 256 changes the area of the NVRAM 215 associated with the item ID to the value in the “initial value” column for each extracted item via the setting value storage module 262.

Next, the setting reset application 256 repeatedly executes the processing of steps S903 to S907. This repetitive processing is similar to that described above with reference to FIG. 12, and thus the description thereof is omitted.

Specifically, in a case where all settings initialization (all settings reset) is selected, when the security policy setting “permit transmission only for addresses registered in address book” is enabled (ON), the image processing apparatus 200 initializes settings other than the address book setting in the all settings, and when the security policy setting “permit transmission only for addresses registered in address book” is disabled (OFF), the image processing apparatus 200 initializes all the settings (steps S1001 to S1005). Further, the setting value for the setting item on which a limitation is imposed by the security policy is set to the setting value that complies with the limitation (steps S903 to S907).

The above-described processing makes it possible to maintain the limitation on the setting value imposed by the security policy setting in the all settings reset processing. Further, the number of comparison and checking operations in the method according to the present exemplary embodiment is smaller than that in the method of checking whether a limitation is imposed by the security policy setting on all setting items for the image processing apparatus 200, which leads to a reduction in processing load and waiting time for the user. There is a possibility that the processing time for the setting value initialization function may increase and the waiting time for the user may increase in the related art (especially, in an image processing apparatus of a low-end model with a relatively low CPU performance, this effect is noticeable). In the present exemplary embodiment, in contrast, it is possible to suppress an increase in processing load due to an increase in the number of setting items, while preventing a setting from being made against a security policy when the setting value initialization function is executed in the image processing apparatus to which the security policy is applied.

The first exemplary embodiment described above illustrates a method for changing a setting value for a setting item to be initialized to an initial value in each setting reset function when a security policy is set, and further setting the setting value to comply with the limitation imposed by the security policy setting. However, in this method, it is necessary to devise a scheme to exclude the setting item, such as address book information, that cannot recover from a change once changed to its initial value from the reset processing target in advance. A second exemplary embodiment illustrates an example of the setting value initialization function that is also applicable to such a setting item that cannot recover from a change once changed to its initial value, when a security policy is set. The content described above with reference to FIGS. 1 to 10 in the first exemplary embodiment is similar to that in the second exemplary embodiment, and thus the description thereof is omitted.

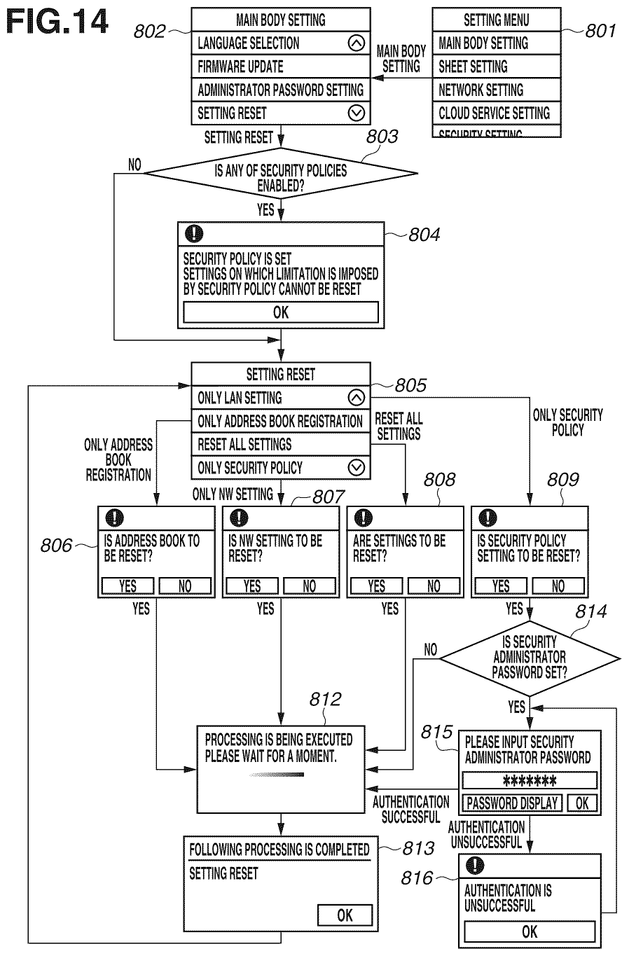

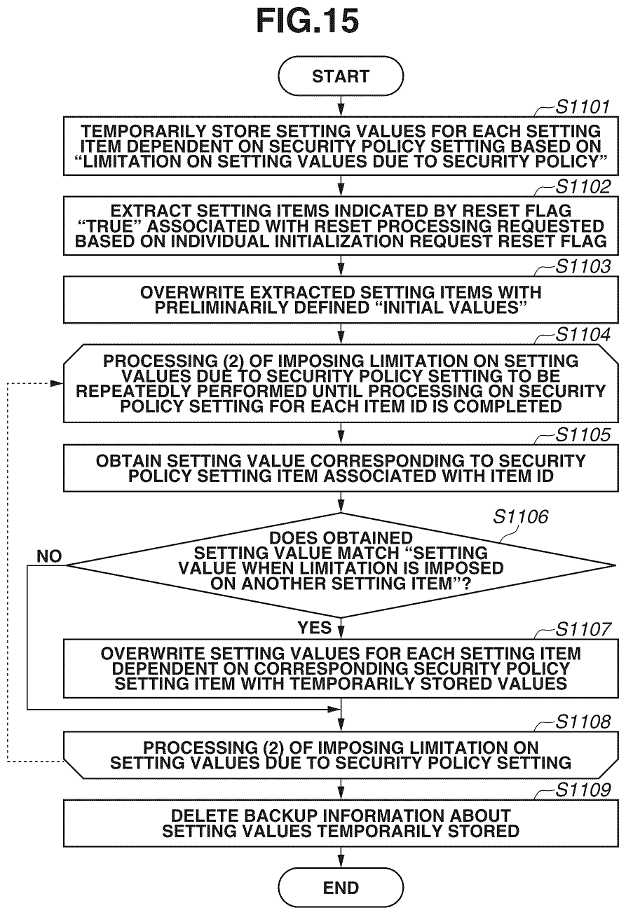

The setting reset functions of the image processing apparatus 200 according to the second exemplary embodiment will be described with reference to FIGS. 14 and 15. Processing in processing flows illustrated in FIGS. 14 and 15 is implemented by the CPU 211 executing programs stored in the ROM 213, and is mainly controlled by the apparatus UI control module 252.

FIG. 14 illustrates a screen flow when various setting values stored in the NVRAM 215 are reset by a UI operation on the main body of the image processing apparatus 200 according to the second exemplary embodiment.

The screen 801 is a setting menu screen to be displayed when a user touches the settings area 235 in a state where the home screen is displayed on the touch panel liquid crystal display 226 of the image processing apparatus 200. When the user touches “main body setting” on this screen, the screen transitions to the screen 802.

The screen flow illustrated in FIG. 14 is similar to the screen flow described above with reference to FIG. 11 in many aspects. Accordingly, only differences will be described below. The screen flow in FIG. 14 differs from that in FIG. 11 in a UI flow for performing address book reset processing. In the screen flow illustrated in FIG. 14, when the user touches the “YES” button on the screen 806, the screen transitions to the screen 812 and the apparatus UI control module 252 requests the setting reset application 256 to perform address book reset processing. Specific operations in various reset processing related to the screen 812 according to the second exemplary embodiment are summarized in the flowchart illustrated in FIG. 15.

FIG. 15 is a flowchart illustrating various reset processing to be performed by the image processing apparatus 200 according to the second exemplary embodiment. The processing in this flowchart is started when the setting reset application 256 receives a request for performing various reset processing, such as address book reset processing, NW setting reset processing, all settings reset processing, and security policy reset processing.

First, in step S1101, the setting reset application 256 generates a list of combinations of an item ID for each setting item and the current setting value for the setting item of the dependency destination indicated by the dependency relationship 410 between the security policy setting and other settings, and temporarily stores the list as backup setting values in the RAM 214.

Next, in steps S1102 and S1103, the setting reset application 256 performs setting change processing based on the initial value indicated by the column 403 and the individual initialization request reset flag indicated by the column 404 in the setting item management information 400. Specifically, in step S1102, the setting reset application 256 extracts items indicated by the individual initialization request reset flag “TRUE” in the column that matches the requested reset processing in the column 404. For example, if address book reset processing is requested, items indicated by the individual initialization request reset flag “TRUE” in the “address book reset” column may be extracted, and if all settings reset processing is requested, items indicated by the individual initialization request reset flag “TRUE” in the “all settings reset” column may be extracted.

In step S1103, the setting reset application 256 changes the area of the NVRAM 215 associated with the item ID to the value in the “initial value” column for each extracted item via the setting value storage module 262.

Next, the setting reset application 256 executes repetitive processing of steps S1104 to S1108. This repetitive processing is repeatedly performed for each item ID until the processing on all items in the security policy setting is completed. Specifically, the processing may be performed in order from “prohibit use of direct connection” corresponding to the item ID “10001” and the item ID as the processing target may be incremented every time the processing is repeated. When the processing on all item IDs within the range of the security policy setting is completed, the repetitive processing ends, and the processing is completed.

In step S1105, the setting reset application 256 obtains the setting value associated with each item ID for the security policy setting as the processing target from the NVRAM 215 via the setting value storage module 262.

Next, in step S1106, the setting reset application 256 checks whether the setting value obtained in step S1105 described above matches the “setting value when a limitation is imposed on another setting item” in the row of the processing target item ID among the dependency sources indicated by the dependency relationship 410 between the security policy setting and other settings. If the setting reset application 256 determines that the obtained setting value matches the “setting value when a limitation is imposed on another setting item” (YES in step S1106), the processing proceeds to step S1107. If the obtained setting value does not match the “setting value when a limitation is imposed on another setting item” (NO in step S1106), the processing proceeds to step S1108.

In step S1107, the setting reset application 256 forcibly sets the setting value for each setting item dependent on the processing target item ID to the setting value that is temporarily stored as the backup setting value in the RAM 214. Specifically, the setting reset application 256 obtains the setting value paired with the item ID that matches the item ID for the setting item of the dependency destination from the backup setting values obtained in step S1101 described above. Then, the setting reset application 256 changes the area of the NVRAM 215 associated with the item ID for the setting item of the dependency destination to the value obtained from the backup setting values via the setting value storage module 262. After the processing of step S1107 is completed, the processing proceeds to step S1108.

In step S1108, if the setting reset application 256 determines that there is an item ID on which the security policy setting processing is not performed yet, the processing returns to step S1104. If there is no item ID on which the security policy setting processing is not performed yet, the processing proceeds to step S1109.

In step S1109, the setting reset application 256 deletes setting value backup information temporarily stored in the RAM 214, and the processing in this flowchart is completed.

Specifically, in the processing of collectively initializing a plurality of settings, the image processing apparatus 200 according to the second exemplary embodiment performs setting value backup processing and then performs initialization processing (steps S1101 to S1103). Further, the image processing apparatus 200 makes a setting based on the backup information for the setting on which a setting value limitation is imposed by the security policy (steps S1104 to S1108).

As described above, the current setting value for the setting item on which a setting value limitation can be imposed in various setting reset processing is temporarily stored as backup information, and if a limitation is actually imposed on the setting value, the setting value may be written back to the previous value before the change based on the backup information, thereby making it possible to perform reset processing while maintaining the limitation. This method can achieve setting value initialization processing that is also applicable to the setting item that cannot recover from a change once changed to its initial value, when a security policy is set. Further, the number of comparison and checking operations in the method according to the present exemplary embodiment is smaller than that in the method of checking whether a limitation is imposed in the security policy setting on all setting items for the image processing apparatus of the related art, which leads to a reduction in processing load and waiting time for the user. Consequently, it is possible to suppress an increase in processing load due to an increase in the number of setting items, while preventing a setting from being made against a security policy when the setting value initialization function is executed in the image processing apparatus to which the security policy is applied.

According to the exemplary embodiments described above, it is possible to suppress an increase in processing load due to an increase in the number of setting items, while preventing a setting from being made against a security policy when the setting value initialization function is executed in the image processing apparatus to which the security policy is applied. Especially, in an image processing apparatus of a low-end model with a relatively low CPU performance, this effect is noticeable.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to an aspect of the present disclosure, it is possible to suppress an increase in processing load due to an increase in the number of setting items, while preventing a setting from being made against a security policy when a setting value initialization function is executed in an image processing apparatus to which the security policy is applied.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-122199, filed Jul. 27, 2023, which is hereby incorporated by reference herein in its entirety.

What is claimed is:

1. An image processing apparatus comprising:
one or more memories storing instructions; and
one or more processors capable of executing the instructions causing the image processing apparatus to execute initialization processing for collectively initializing a plurality of settings on the image processing apparatus,
wherein, as the initialization processing based on selection of initialization of a network setting, the network setting is initialized, and on a setting on which a setting value limitation is imposed by a security policy, setting processing is executed in compliance with the limitation.

2. The image processing apparatus according to claim 1, wherein, as the initialization processing based on selection of initialization of a setting for an address book, in a case where a specific security policy is set, the setting for the address book is not initialized, and in a case where the specific security policy is not set, the setting for the address book is initialized.

3. The image processing apparatus according to claim 2, wherein in a case where the setting for the address book is not initialized in the initialization processing, a notification indicating that the setting for the address book is not initialized is executed.

4. The image processing apparatus according to claim 2, wherein the case where the specific security policy is set is a case where a setting for permitting transmission only for an address registered in the address book.

5. The image processing apparatus according to claim 1,
wherein as the initialization processing based on selection of initialization of all settings on the image processing apparatus, in a case where a specific security policy is set, settings other than the setting for the address book in the all settings are initialized, and
wherein in a case where the specific security policy is not set, the all settings are initialized.

6. The image processing apparatus according to claim 5, wherein, as the initialization processing based on selection of initialization of the all settings on the image processing apparatus, on a setting on which a setting value limitation is imposed by a security policy, setting processing is executed in compliance with the limitation.

7. A control method for an image processing apparatus, the control method comprising:
executing initialization processing for collectively initializing a plurality of settings on the image processing apparatus,
wherein, as the initialization processing based on selection of initialization of a network setting, on a setting on which a setting value limitation is imposed by a security policy, setting processing is executed in compliance with the limitation.

8. The control method according to claim 7, wherein, as the initialization processing based on selection of initialization of a setting for an address book, in a case where a specific security policy is set, the setting for the address book is not initialized, and in a case where the specific security policy is not set, the setting for the address book is initialized.

9. The control method according to claim 7, wherein, as the initialization processing based on selection of initialization of all settings on the image processing apparatus, in a case where a specific security policy is set, settings other than the setting for the address book in the all settings are initialized, and in a case where the specific security policy is not set, the all settings are initialized.
